(19) United States
(12) Patent Application Publication
(10) Pub. No.: US 2022/0026405 A1
(43) Pub. Date: Jan. 27, 2022

(54) IMPROVEMENTS IN OR RELATING TO PROFILING OF PARTICLES USING MICROFLUIDIC DEVICES

(71) Applicants: Fluidic Analytics Limited, Cambridge (GB); Cambridge Enterprise Limited, Cambridge (GB)

(72) Inventors: Tadas Kartanas, Cambridge (GB); Tuomas Pertti Jonathan Knowles, Cambridge (GB); Quentin Alexis Eric Peter, Cambridge (GB); Kadi Liis Saar, Cambridge (GB); Tom Scheidt, Cambridge (GB); Thomas Mueller, Cambridge (GB); Sean Devenish, Cambridge (GB)

(73) Assignees: Fluidic Analytics Limited, Cambridge (GB); Cambridge Enterprise Limited, Cambridge (GB)

(21) Appl. No.: 17/277,223

(22) PCT Filed: Sep. 19, 2019
(86) PCT No.: PCT/GB2019/052635

§ 371 Date: Mar. 17, 2021

(30) Foreign Application Priority Data
Sep. 20, 2018 (GB) 1815360.1
Jul. 18, 2019 (GB) 1910277.1

(51) Int. Cl. G01N 30/74; G01N 15/14

(52) U.S. Cl. CPC G01N 30/74; G01N 2030/8831; G01N 15/1484

(57) ABSTRACT

A device and a method is provided for profiling particles such as proteins. The device comprises: a liquid chromatography column (16) in a mixture separation module (10); a fractionation device (22, 24) and a plurality of microfluidic analysis modules (26, 28) in a microfluidic network (14). The microfluidic analysis modules are configured to provide multi-dimensional analysis of the particles. Furthermore, a fluidic flow adaptor (20) allows for controlled flow between separator (16) and the microfluidic network to provide a continuous fluid flow.

The present invention relates to improvements relating to the profiling of particles, in particular, proteins, in microfluidic devices.

Non-covalent interactions are predominately responsible for the folding, binding and assembly of many proteins. Protein interactions with other partners are often associated with its specific amino acid sequence and its post-translational modification. These unique properties can lead to either hydrophobic or electrostatic noncovalent interactions. The overall charge of proteins and complexes in solution can be dependent on the total compositions of accessible charged groups and can usually be determined by the isoelectric point (pI), the pH value where the net charge is zero. Protein interactions, oligomerisation and assembly are highly regulated processes in organisms and influence the individual function of each protein. Uncontrolled and unregulated misfolding and interaction of proteins is an important class of malfunction, and often leads to protein aggregation. Therefore, understanding protein-protein interactions in complex mixtures is of key relevance in modern protein science.

In proteomics, the understanding of protein-protein interactions is key and therefore there is a strong driver within the industry to understand these interactions. In order to probe and predict these reactions, each protein needs to be profiled. This means, within the context of this patent, that the individual and fundamental biophysical properties of the protein need to be determined. These include, but are not limited to, the isoelectric point (pI), hydrodynamic radius, hydrophobicity, molecular weight, stoichiometry of binding partners and binding affinity.

Techniques capable of characterising complex mixtures are limited in the field and these techniques are only commonly used to provide unidimensional information. As protein mixtures are highly dynamic and composition depends on various exogenous factors such as temperature, pH, local protein/salt concentration, viscosity and matter of state, it can be challenging to accurately determine the physiological and biophysical properties of the proteins within a mixture.

One of the most powerful methods capable of profiling these particles is mass spectrometry. This technique requires the transfer of the analyte from liquid to gaseous phase. This diminishes or completely destroys biologically relevant interactions such as non-covalent protein-protein interactions and also protein-ligand interactions. This technique is therefore destructive of the sample that it seeks to profile and is capable of providing only limited information about the native state of the proteins present.

The destructive and incomplete analysis available using mass spectrometry has led to a focus on protein characterisation methods that are able to determine protein properties in solution. There are many such techniques, including nuclear magnetic resonance spectroscopy, circular dichroism, isothermal titration calorimetry, fluorescence spectroscopy, dynamic light scattering, multi-angle light scattering and analytical centrifugation. Most of these techniques are capable of measuring a single attribute at any one time. These attributes include the structure, binding properties, Stokes radius or charge. This is very limiting in terms of profiling throughput as a number of separate experiments are needed in order to characterise a protein mixture fully.

Therefore, there is a requirement to provide experimental apparatuses and methods for measuring multiple parameters of one or more particles such as proteins in a sample mixture. However, techniques providing an experimental set-up for measurements of multiple parameters are rare and often non-applicable for a wide variety of proteins. Conventional approaches, including but not limited to, size-exclusion chromatography coupled multi-angle light scattering (SEC-MALS), 2D Gel electrophoresis, liquid chromatography coupled mass spectrometry (LC-MS), Liquid chromatography coupled nuclear magnetic resonance spectroscopy (LC-NMR), high performance anion exchange coupled pulsed amperometric detection (HPAECPAD) and electrochromatography have been used to obtain multiple parameters of a protein in the sample mixture. While these techniques have their advantages, there are known limitations for using these techniques. For instance, some approaches require special probes for example isotopes, oxidisable functional groups, protein tags or, elevated temperature conditions, sample vaporization, or use of high sample concentration for analysis. Other methods often show non-specific binding and/or low signal to noise ratio for example, NMR spectroscopy and capillary electrophoresis.

Microfluidic devices, sometimes referred to as lab on a chip devices, enable the manipulation and control of small volumes of fluid, typically in the range of picolitres to microliters, in microfabricated structures. Microfluidic systems have a compact footprint and can therefore parallelise experiments thus reducing overall time.

It is against this background that the present invention has arisen.

According to the present invention there is provided a device for profiling particles such as proteins, the device comprising: a liquid chromatography column; a plurality of microfluidic analysis modules; wherein the microfluidic analysis modules are configured to provide multi-dimensional analysis of the particles; and wherein the flow of fluid through the device is smoothed to provide a consistent and continuous fluid flow.

Microfluidic device can be an optimal solution to utilise without the requirement for large sample volumes. Microfluidic devices may allow manipulation and control of small quantities of one or more fluid samples, usually in the range of pico- to microliters. A wide range of liquid chromatography methods for example, size-exclusion, reversed phase, ion-exchange and affinity chromatography can be used in conjunction with microfluidic devices. Microfluidic devices may be used for mapping out physiological protein complexes from endogenous samples. For chromatography methods, the bedding material, known as the stationary phase, can influence the purification of proteins within a mixture and can comprise biomolecules such as dextran, agarose or cellulose and synthetic polymers such as polyacrylamide, polystyrene or silica-based polymers. The selection of the mobile phase may control the interplay between the separating molecules and the matrix and is usually organic or buffered. By combining liquid chromatography (LC) protein separation and microfluidics, the present invention is provided to enable multidimensional characterisation of complex mixtures and sample fractionation. By measuring the sample composition in the condensed phase, single proteins and/or protein complex formation under native conditions may be analysed. Moreover, the microfluidic systems according to the disclosure of the present invention may allow for the simultaneous determination of multiple parameters such as hydrodynamic radius and electrophoretic mobility of molecules in a quantitative manner in complex mixtures.

In another advantage, the use of LC with a plurality of microfluidic analysis modules may only require a small fraction of sample for analysis whereas the main volume of the sample can be collected and be used for further evaluation. Due to the compact size of microfluidic devices, the addition of microfluidic systems/microfluidic analytical modules into existing LC systems can be relatively simple to implement. Thus, this can be highly advantageous as it provides a low cost, simple and effective apparatus and method for profiling particles such as proteins.

By “consistent and continuous flow”—we mean that the flow rate will vary by no more than 10%, no more than 5% or even less than 2%. Consistent flow rate is important because it is required to enable the sizing of the particles by diffusion and measure the electrophoretic mobility.

The consistent flow rate can be at least partially achieved through selection of liquid chromatography column. For example, some chromatography columns are provided with two pumps in anti-phase to improve the flow stability.

Alternatively, or additionally, the consistent flow rate can be achieved by introducing some compliance into the system. This is counter intuitive within the context of microfluidic devices because there is usually a strong driver to reduce the compliance within the system as this leads to slow fluidic response times and results in variable hydrodynamic resistance which, in turn, makes it difficult to predict flow at a junction.

Alternatively, or additionally, the consistent flow rate can be achieved by providing a smooth buffer flow on dilution of the sample flow. The buffer may be provided in a volume around ten times the volume of the sample flow and therefore the provision of a continuous flow of buffer will ensure that the combined, diluted flow has a consistent flow rate.

Multi-dimensional analysis, within the context of this patent application, means analysis of a particle, such as a protein using two or more different attributes of the particle, substantially simultaneously.

Multidimensional analysis may be achieved by a number of different permutations and combinations of key techniques. In some embodiments and examples, simultaneous acquisition of multidimensional characteristics can be advantageous as sequential measurements can be taken to show different states and composition of unequilibrated molecular mixtures.

In some embodiments a single image is taken and from that image multiple data points can be ascertained. An example of this may be the calculation of the charge of the particle calculable from an image showing diffusional broadening and electrophoretic motion giving the electrophoretic mobility of the particle. In some embodiments, multiple separate measurements can be synchronized in order to facilitate the multidimensional analysis. In some embodiments, data can be combined and then extrapolated to provide the multidimensional analysis.

In a case when the sample is not well separated, i.e. has multiple molecular peaks overlapping with each other, it is very difficult to measure the biophysical properties of molecules within these peaks. By using the low noise signal at the first absorbance detector and taking the second derivative of absorption, we can estimate the molecular elution positions for the different molecular species. The corresponding molecular elution volumes are then used to pick data points from the continuous size and electrophoretic mobility measurement dataset and give an estimate of the biophysical properties of molecules which is difficult to obtain otherwise.

Multidimensional analysis may include calculation of the isoelectric point. Calculation of the isoelectric point enables predictions of the behaviour of the particle, especially protein, under different conditions. Typically, a pH gradient has been generated and then it has been determined the position of the particle across that gradient and that pH has been identified as the isoelectric point. However, this workflow does not permit the charge to be determined. However, this process is considerably improved by taking a multidimensional approach and measuring the deflection at two discrete pH values and combining these measurements with diffusional sizing. By making this multidimensional combination, a calculation of the isoelectric point can be achieved by the measurement of deflection at only two different pH values. The multidimensional analysis therefore simplifies the overall analysis and reduces the number of data points required in order to calculate the isoelectric point.

A fractionation device may be provided. The fractionation device may be downstream of the liquid chromatography column and upstream of the microfluidic analysis modules. In many embodiments, the fractionation of the fluid flow precedes the multi-dimensional microfluidic analysis. However, in some embodiments, it may be desirable to collect doubly separated fractions and this could be achieved by the provision of the fractionation device downstream of at least one of the microfluidic analysis modules.

The device may further comprise a controller configured to use the multi-dimensional analysis obtained from the microfluidic analysis modules in order to assess the quality of the liquid chromatography column.

This feedback loop provides quality assurance for the liquid chromatography column and also aids in the identification of unknown eluting species.

The controller may be further configured to use the multi-dimensional analysis obtained from the microfluidic analysis modules in order to control the fractionation device.

Furthermore, according to the present invention there is provided a device for conducting multi-dimensional profiling of particles such as proteins, the device comprising: a liquid chromatography column; more than one microfluidic analysis modules; and wherein the device is configured to provide continuous real-time data acquisition.

The device may further comprise a detector configured to, detect and record data from each microfluidic analysis module.

The detector may include a microscope and a detector such as a camera for recording the data. The detector may be optical or non-optical. If the detector is non-optical it may be selected from the following non-exhaustive list of sensors: a biosensor; an electrochemical sensor; a point detector that is scanned across the region to be sensed; a mass sensor such as a quartz crystal microbalance or cantilever system. Alternatively, the detector may work using chemiluminescence which does not rely on an illumination source but rather the chemical stimulation leading to light emission with subsequent capture via an optical sensor.

The detector may be further configured to illuminate at least part of the microfluidic analysis module. The illumination source may be an LED or a laser.

The data may be recorded using a CCD camera, CMOS camera or other optical data recording device.

The device may further comprise a flow adapter. The flow adapter is provided to smooth the fluid flow so that it is constant. Constant within this context means that there is less than 10% variation in flow over time. In some embodiments, this threshold may be reduced to less than 5% or even less than 2%. Alternatively or additionally, the flow adapter connects the chromatographic column with a plurality of microfluidic analysis devices.

The device may further comprise a device for measuring optical absorption. The device for measuring optical absorption, such as UV absorption, may provide an absorption measurement cell for monitoring the separated molecules. The continuous data received from the microfluidic modules can be matched to the absorption measurements and thereby the measured peaks can be assigned to data points. In some embodiments, the second derivative of the spectrum can be used to identify the most significant sub-peaks. In circumstances where there is prior information about the peaks, for example, which peak is which molecule, it will then be possible to assign the observed data to the known molecules.

The microscope may be an intrinsic fluorescence microscope or an epifluorescence microscope. The epi-fluorescence microscope may be matched to the wavelength of the fluorescent label deployed.

All of the data to be observed and recorded may be configured to fall within the field of view of the microscope.

Furthermore according to the present invention there is provided a method of multi-dimensional profiling of particles such as proteins present in a fluid sample; the method comprising the steps of: introducing the fluid sample containing the particles to be profiled into a liquid chromatography column; consistently and continuously flowing the fluid output from the column into each of a plurality of microfluidic analysis modules in parallel; detecting data pertaining to multiple characteristics of the particles by observing the fluid within the microfluidic analysis modules; and combining the data to calculate one of more attributes of the particle profile.

The characteristics detected may include the hydrodynamic radius and the electrophoretic mobility and the attribute calculated may therefore be the effective charge.

Alternatively or additionally, the characteristics detected may be the mobility and diffusional size and the attribute calculated may therefore be the isoelectric point.

The method may further comprise fractionating the fluid containing the particles. The fractionation of the fluid may include 90% of the sample eluting from the liquid chromatography column.

In some embodiments, the initial sample may be a 40 ul sample size and may be a high concentration protein solution. After separation, each of the proteins is diluted 5-10 times depending on the chromatography conditions. Typical operation time of a column is 1-3 hours depending on the flow rate. Laminar flow is established both on chip and at the flow adapter, prior to the introduction of the proteins which are subsequently introduced onto the chip sequentially. In this way, the device of the present invention minimises or even eliminates losses of sample due to transient processes. The flow adapter samples continuously all of the sample coming from the chromatography column so that the whole sample is analysed.

The invention will now be further and more particularly described, by way of example only, and with reference to the accompanying drawings, in which:

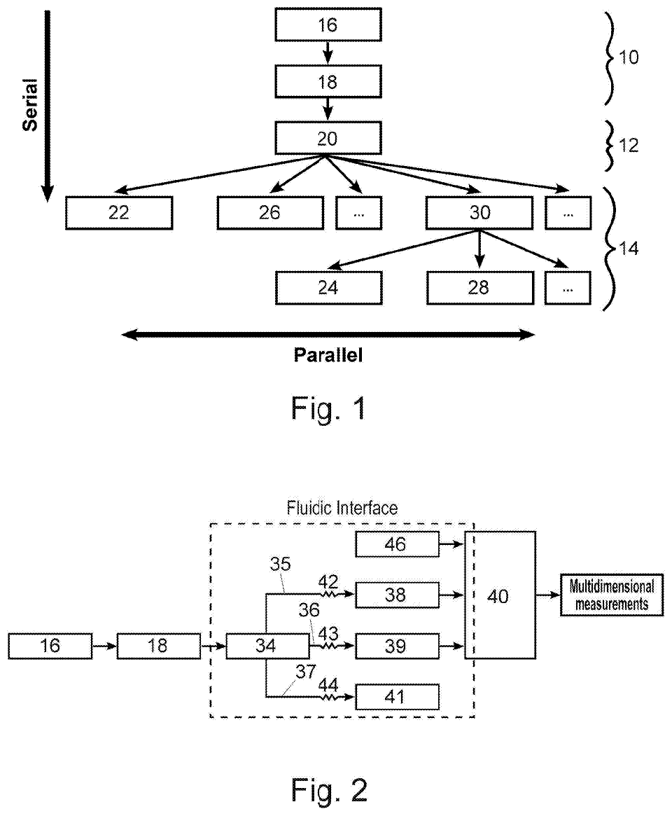

FIG. 1 provides a schematic scheme of a system and a method according to the present invention;

FIG. 2 provides a schematic scheme of the flow adapter according to FIG. 1;

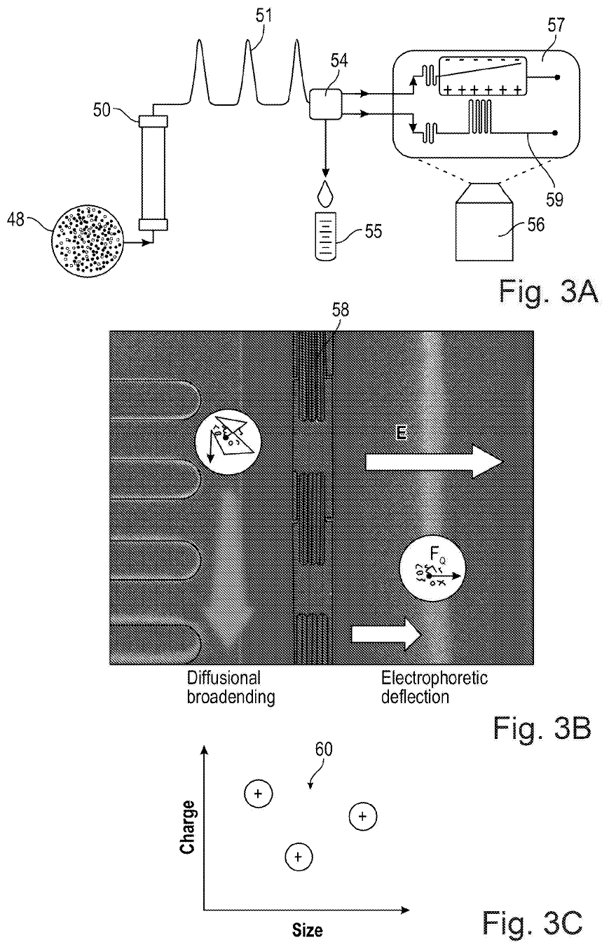

FIG. 3A to 3C provides an overview of an HPLC purification column with analytical microfluidic and various devices for biophysical characterisation of a sample;

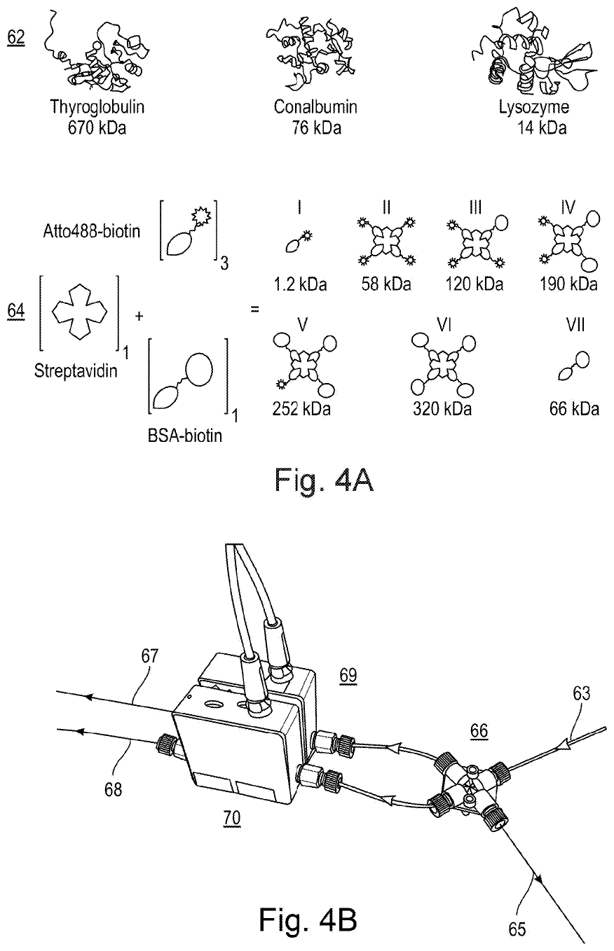

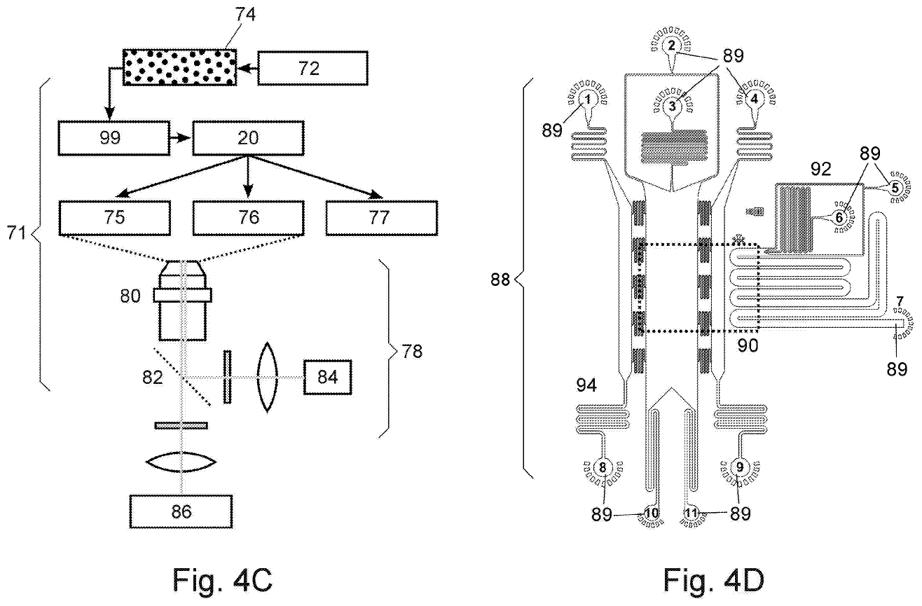

FIGS. 4A to 4D provides a general experimental set up according to the present invention;

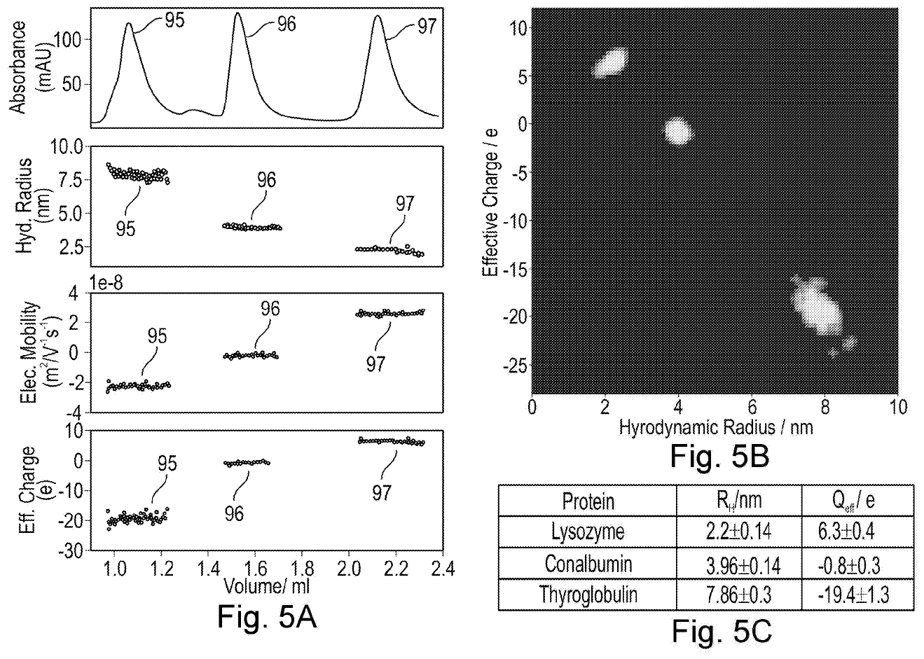

FIGS. 5A to 5C shows results for label-free multi-dimensional biophysical characterisation;

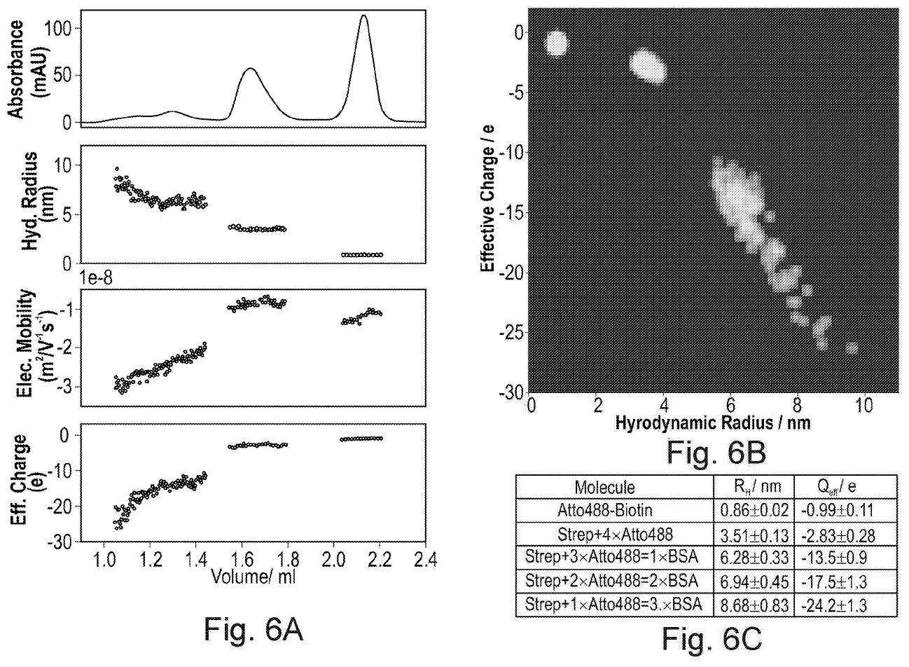

FIG. 6A to 6C shows results for labelled heterogeneous mixture multi-dimensional biophysical characterisation,

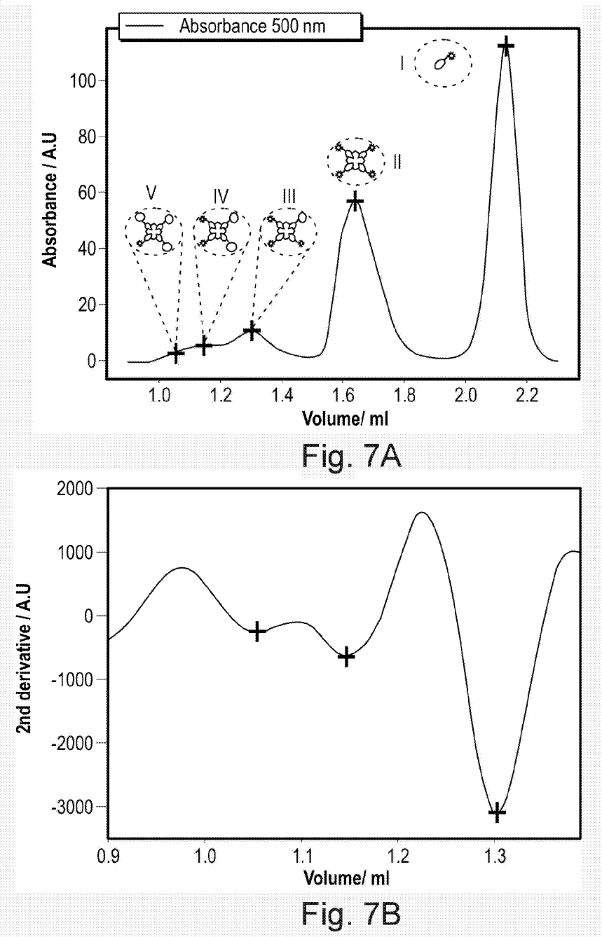

FIG. 7A to 7B shows the absorbance of complexes at 500 nm after liquid chromatography separation;

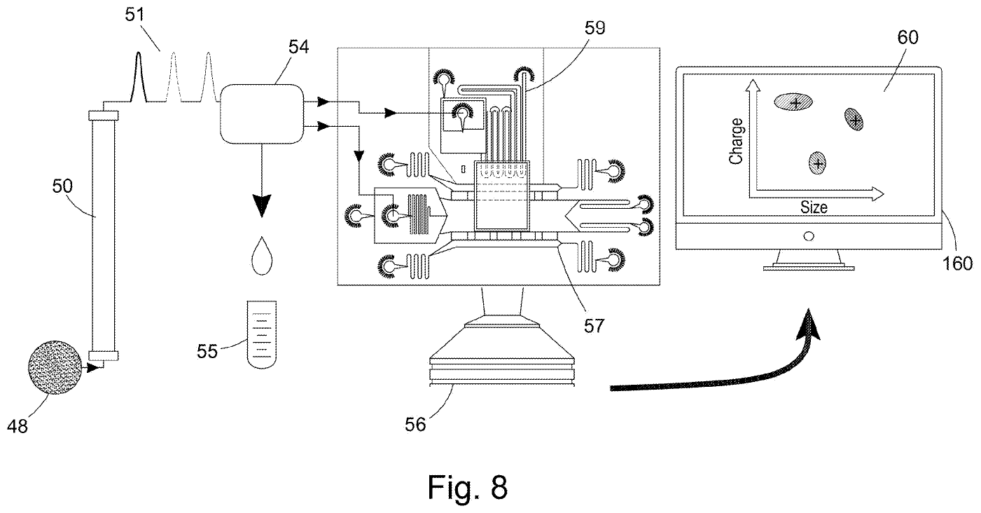

FIG. 8 shows a schematic of an integrated liquid chromatography with analytical microfluidics;

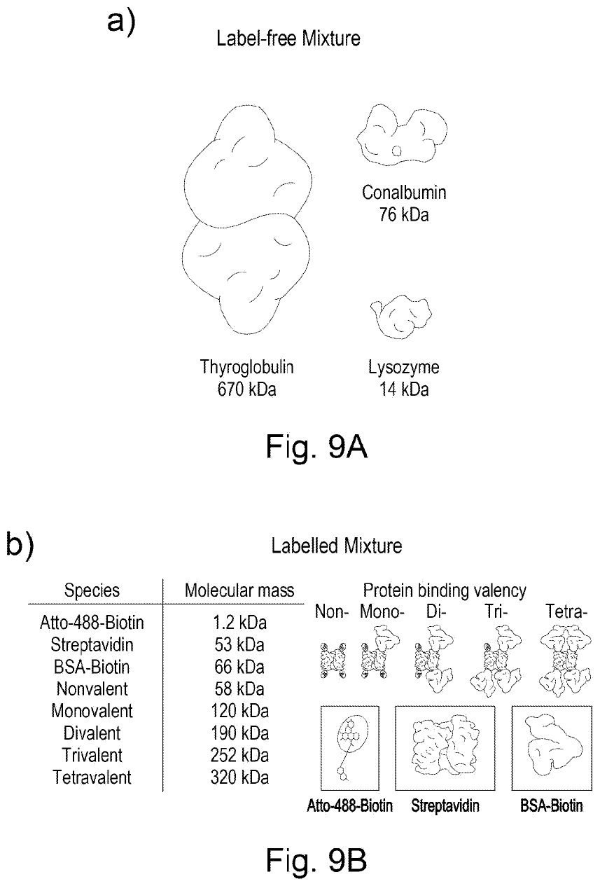

FIG. 9A shows a label-free mixture for measurements and FIG. 9B shows a labelled mixture for measurements;

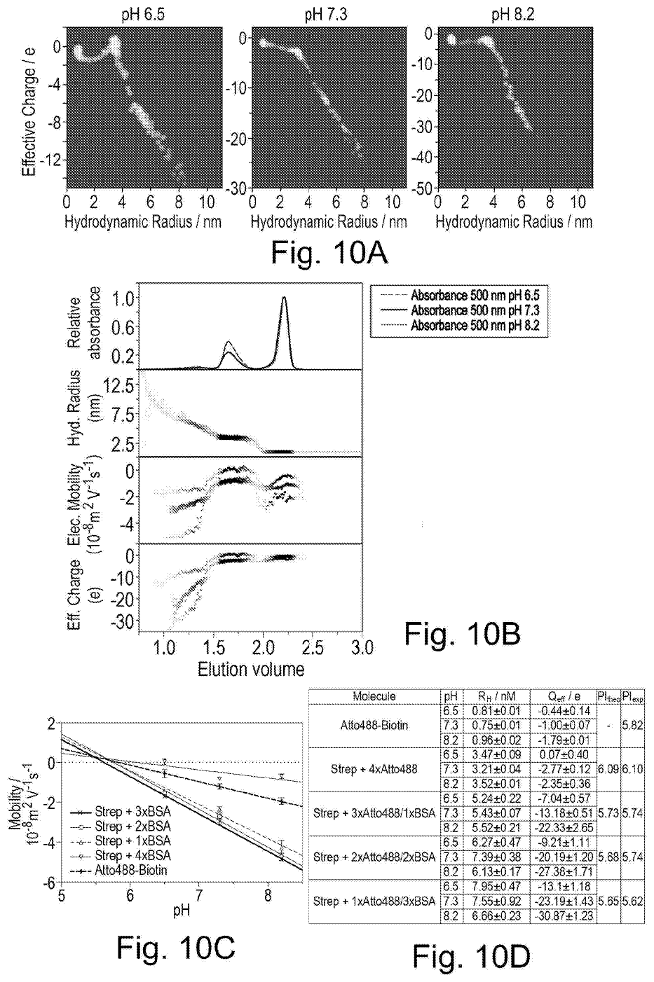

FIGS. 10A to 10D provides data of labelled streptavidin/BSA/Atto488 mixture at three different pHs; and

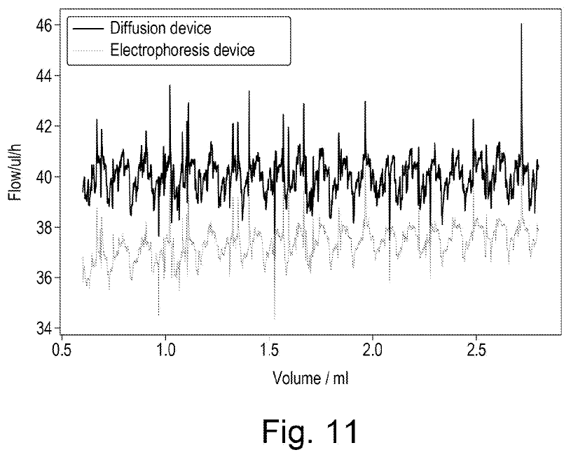

FIG. 11 shows the flow of the sample in a diffusion sizing device and a free flow electrophoresis device.

The present invention relates to a serial combination of a preparative analyte separation technique with parallel (or parallel and serial) analytical and preparative fluidic device network capable of sample fractionation and simultaneous multidimensional analyte characterisation.

Referring to FIG. 1, there is provided a schematic scheme showing a system and method of the present invention. FIG. 1 shows a system consisting of three modules 10, 12, 14. The first module 10 provides a mixture separation combined with analyte quantification. The separation is provided by a separator 16 selected to provide efficiency in bulk flow separation e.g. size exclusion chromatography. Separation of the fluids is the detected by a detection device 18. The second module 12 is a fluidic flow adapter 20 allowing for controlled flow between the fluid input from separator 16 and multiple fluidic outputs in the third module, a microfluidic network 14. The microfluidic network 14 includes parallelised fractionation 22, 24, analytical 26, 28 and a further separation 30 devices.

Referring to FIG. 1, there is shown a separator 16, which may provide a high flow rate or a low flow rate of fluids, combined in series with a parallelised microfluidic analytical and separative network containing arbitrary number of components. The flow mismatch between the high flow (0.06-60 ml/h) from separator 16 and the low flow (0-100 ul/h) microfluidic devices (Analytical 26, Separation 30, Analytical 28, etc.) can be managed with a microfluidic flow adapter 20, as shown in FIG. 2. The flow adapter 20 is configured to distribute the sample eluting from separator 16 to the fractionation device 22 e.g. the Fractionation device may contain approximately 0-95% total volume from separation in the separator 16. The flow adapter 20 may be adapted to distribute the sample eluting from the separator 16 to the remaining parallelised preparative and analytical device network.

The fluidic network can be performing simultaneous measurements on the physical properties of the separated analytes e.g. hydrodynamic radius, electrophoretic mobility, effective charge, isoelectric point. A detection device 18 yields a signal readout representing the analyte concentration variation in time after separation in the separator 16 and can be used to reference and match the sequence of the measured analyte physical properties in the parallelised fluidic network. A detection signal from the detection device 18 can also be used to introduce weight for the confidence/importance in each of the measured analyte physical properties. The network may include an arbitrary number of further separation modules e.g. Capillary, Free-flow electrophoresis enabling more complex analyte mixture separation and characterisation.

FIG. 2 shows a schematic diagram of the flow adapter 20. Fluid eluting from the separator 16 is distributed via the flow adapter 20 between three (or more) fluid paths 35, 36, 37. FIG. 2 shows that split fluids are distributed into two detection devices or flow sensor devices 38, 39 on chip 40 for multidimensional measurements 55 and a fractionation outlet 41. The flow of the fluids are dependent on the ratio of hydrodynamic resistances R₁ 42, R₂ 43 and R₃ 44 and the additional buffer and reagent flows are controlled by a syringe/pressure pump 46.

Referring to FIG. 3A to 3C, there is shown a schematic of a system and method according to the present invention. In particular, FIG. 3A to 3C shows integration of a high performance liquid chromatography (HPLC) purification column 50 with analytical microfluidics. FIG. 3A depicts a protein mixture 48 being separated on a liquid chromatography (LC) column 50 and connected to a low flow microfluidic chip 52 via a flow adapter 54. FIG. 3B shows a microscope image 56 of the microfluidic chip 52 measuring protein hydrodynamic radius and electrophoretic mobility 58. FIG. 3C shows the latter measurements yield protein effective charge and, thus, the mixture component characteristics can be visualised in a continuous 2-dimensional charge versus size map 60.

In FIG. 3A, there is shown an example of the present invention in which a HPLC chromatography column, typically a HPLC Size Exclusion column 50, which can be used to separate an analyte mixture 48, e.g. a selected mixture of three proteins with varying in size and isoelectric point (pI), while monitoring the separated sample absorption at multiple wavelengths 51. The separated mixture can then be directed into the flow adapter 54 distributing the flow between a sample fractionation outlet 55, a free-flow electrophoresis device 57 and a diffusional sizing device 59 as shown in FIGS. 3A and 3B. The design of the two microfluidic devices 57, 59 can be tailored to match the requirements of the setup such that the analyte sizing and electrophoretic mobility measurements could be performed simultaneously with an epi-fluorescent microscope 56. The microscope 56 can provide an image 58 of the diffusional and electrophoretic mobility measurement as shown in FIG. 3B. Referring to FIG. 3C, the diffusional and electrophoretic mobility measurements can then be visualised in a continuous 2-dimensional charge versus size map 60.

Referring to FIGS. 4A to 4D, there is shown an experimental set up according to the present invention. FIG. 4A shows the preparation of a label-free mixture 62 and a labelled mixture 64 in order to demonstrate the functionality of the systems and methods of the present invention.

The label-free mixture 62 comprises thyroglobulin, conalbumin and lysozyme. The second heterogeneous seven component mixture 64, which is prepared by mixing streptavidin, biotinylated BSA and Atto-488 molecules, comprises five Atto-488 labelled complexes (molecules I-V).

To demonstrate the functionality of the method according to the present invention, a mixture of three proteins varying in size and isoelectric point (pI): bovine thyroglobulin (Mw=670 kDa, pI=4.5, GE Healthcare, 28-4038-42), chicken conalbumin (Mw=76 kDa, pI=6.7, GE Healthcare, 28-4038-42,) and chicken lysozyme (Mw=14.3 kDa, pI=9.3, Sigma-Aldrich, L6876) may be selected. The proteins can be diluted in a 100 mM sodium HEPES buffer (pH=7.3) at a ratio of 4.6:33:110 μM respectively; total sample volume 40 μL. The second system can be used to generate a heterogeneous sample based on Streptavidin-Biotin complex formation, which may be one of the strongest known non-covalent interactions between a protein and a ligand. A mixture can be prepared by incubating Streptavidin (Prospec, Israel, PRO-791), biotinylated bovine serum albumin (Generon, UK, 7097-5) and a biotinylated Atto-488 (ATTO-TEC GmbH, Germany) dye at a ratio of 1:1:3 (20:20:60 μM, total volume 40 μL) for typically about an 1 hour at room temperature in 10% Phosphate buffered saline solution (0.1×PBS, pH=7.3). The mixture is expected to form seven distinct complexes with sizes ranging from 1 kDa to 300 kDa, as shown in FIG. 4A. Five of the complexes (I-V) contain an Atto-488 fluorophore and, therefore, the latter molecules can be the focus of detection and analysis.

In FIG. 4B, there is shown a microfluidic flow adapter 66 matching the flow between a Liquid Chromatography and microfluidics over two orders of magnitude. The microfluidic flow adapter having an input flow 63 from a HPLC column and a fractionation outlet 65. The flow is split between the Fractionation outlet 65 and Outputs A 67 and B 68. The flow through the outlets A 67 and B 68 is monitored with one or more flow sensors, such as flow sensors 1 69 and 2 70 as illustrated in FIG. 4B.

The flow adapter 66 interface may enable standard liquid chromatography (LC) fractionation and simultaneous multi-dimensional eluting molecule characterisation. The LC separation on AKTA Pure can be driven by two high pressure pumps maintaining a highly stable flow of 10 μL/min=600 μL/h with a 1-5% fluctuation level depending on the buffer and the age of separation column. The microfluidic flow adapter 66 with carefully adjusted resistances can be used for distributing the incoming fluid from the LC absorption cell between one or more e.g. two microfluidic sample inlets and a fractionation outlet. The flow rates at the chip ports 3 and 6 89 may be measured to be at 40.0±0.7 μL/h and 37.4±0.7 μL/h respectively, which may represent the electrophoresis device and diffusional sizing sample inlets on the chip. The rest of the post LC separation fluid about 90% can be collected via the fractionation outlet 65.

Referring to FIG. 4C, there is provided a simplified schematic of the whole detection setup 71. As shown in FIG. 4C, a sample mixture 72 is separated with an HPLC column 74 followed by a device 99 for measuring optical absorption. About 10% of the total flow can be directed to the microfluidic diffusional sizing 75 and free-flow electrophoresis 76 devices which are monitored continuously with a fluorescence microscope 78, comprising components such as an objective 80, a dichroic mirror 82, an LED 84 and a CCD camera 86. The remaining 90% of the sample is introduced to a fractionation device 77.

As shown in FIG. 4D, a microfluidic chip 88 is adapted to provide a microscope field of view 90 in addition to providing several devices such as diffusional sizing 92 and free-flow electrophoresis 94 devices on the microfluidic chip 88. The microfluidic chip also comprises a plurality of ports 89 which are used for continuous on-line measurements of individual molecule. As an example, the hydrodynamic radius, electrophoretic mobility and/or effective charge of a component can be measured.

The microfluidic device may be custom designed for fitting two distinct analytical blocks in one fluorescence microscope field of view. The first block—the diffusional sizing device—may have a long diffusion channel of length L_{D}=43 mm, width of W_{D}=300 μm and height of H_{D}=55 μm, as illustrated in FIG. 4D). The positions for the diffusion profile acquisition may be chosen to allow a high sizing dynamic range and fixed to distances of 3.1 mm, 8.8 mm, 12.4 mm, 17.9 mm, 21.5 mm, 36.7 mm and 40.3 mm from the sample injection point. a degassed co-flow buffer (same as the LC mobile phase) may be injected at a 290 μL/h flow rate with a neMESYS syringe pump (CETONI GmbH, Germany) into port 5 of the device, as shown in FIG. 5D. The Outlet A from the microfluidic flow adapter may be connected to the sample inlet (port 6) on the diffusional sizing device. The injected sample diffusion profile can be recorded and may be fitted to numerical diffusion simulations. By combining liquid chromatography and diffusional sizing inline the mixture may be separated to determine the diffusion constant D (and the hydrodynamic radius) of the separated mixture components eluting from the column.

Referring to FIG. 4D, the second component of the microfluidic chip can be a free-flow electrophoresis device with liquid electrodes, which may be designed to create up to 30 V/cm transverse electric fields on the microfluidic chip while avoiding bubble formation and electrolysis product build up on the chip. A conductive 3 M KCl electrolyte solution may be injected into ports 1 and 4, as shown in FIG. 4D, at flow rates of 150 μL/h. A degassed buffer solution may be injected at the port 2 at a flow rate of 300 μL/h using the neMESYS syringe pump and, finally, the output B from the fluidic adapter may be connected to port 3 of the free-flow electrophoresis device. Thus, the device of the present invention enables the electrophoretic mobility measurement of the separated molecular species eluting from the column by determining the sample deflection in the electrophoresis chamber in a transverse electric field. The mobility of a charged particle may be given by an equation:

$$μ = \frac{υ}{E} = \frac{Q}{V d h} x$$

where v is the transverse velocity, E—the applied electric field, x—the measured profile deflection, V—the applied voltage across the channel, d—the distance of the profile deflection measurement along the channel and h—the channel height.

Referring to FIG. 5A to 5C, there is shown plots to illustrate Label-free thyroglobulin, conalbumin and lysozyme multidimensional biophysical characterisation. FIG. 5A shows a mixture being separated into three major peaks 95, 96, 97 and the eluting molecule size, electrophoretic mobility and effective charge can be measured continuously. In FIG. 5B, there is provided several individual measurements being conducted at approximately every 20 seconds can then be weighed based on the molecular absorption at 280 nm and binned revealing three major populations 95, 96, 97 in the mixture as expected. FIG. 5C provides a summary of the protein measured characteristics obtained using multi-dimensional biophysical techniques. The elution time (volume) on the absorbance plot (at 280 nm and 500 nm) can be matched with the picture sequence on the epi-fluorescent microscope 56, as shown in FIG. 3A to 3C and presented in FIG. 4C, by identifying the maximum peak intensities on the chromatogram and the fluorescence intensity on the microfluidic device. The analysis yields the mixture component's hydrodynamic radius, the electrophoretic mobility and effective charge every 20 seconds (3 μl volume steps), which can be plotted and shown in FIGS. 5A to C; 6A to C; 7A and 7B.

As illustrated in FIGS. 5A to 5C, a mixture of three unlabelled proteins (thyroglobulin, conalbumin and lysozyme) have been completely separated into three major peaks 95, 96, 97 at volumes 1.06 mL, 1.52 mL and 2.12 mL respectively with a minor conalbumin oligomer peak at 1.34 mL, see FIG. 5A. During the sample elution continuously monitored the hydrodynamic radius Rₕ, electrophoretic mobility ρₑ and the effective charge q. To estimate the separated molecular species biophysical properties more accurately, the corresponding elution volume ranges were determined with setting a 10% maximum peak intensity threshold. Thyroglobulin, conalbumin and lysozyme sizes were measured to be (7.86±0.30) nm, (3.96±0.14) nm and (2.20±0.14) nm with an effective charge of (−19.4±1.3) e, (−0.8±0.3) e and (6.3±0.4) e respectively which is summarised in the table of FIG. 5C. The experimental results can then be binned and weighed based on the molecular absorption intensity at 280 nm as shown in FIG. 5B. Thus, a three protein separation and label-free characterisation can be demonstrated which is represented by the distinct clusters in the 2-D molecular size versus effective charge map shown in FIG. 5B.

Referring to FIGS. 6A to 6C, there is shown plots and results of a labelled heterogeneous streptavidin-BSA-Atto488 mixture characterisation. Referring to FIG. 6A, the separation yielded three major peaks with the first peak containing three overlapping peaks. The five identified labelled molecule complexes can be characterised and a 2-dimensional charge versus size map can be constructed. As shown in FIG. 6B, the points are binned and weighed based on the absorption intensity at 500 nm. Referring to FIG. 6C, the results are summarised in a table showing the estimated biophysical properties of the molecules after identifying the molecular elution volume ranges.

As shown in FIGS. 6A to 6C, the LC separation of the Atto-488 labelled streptavidin-biotin based system resulted multiple sample elution peaks (see FIG. 6A). Referring to FIGS. 6A to 6C, the Atto-488 labelled molecules (complexes I-V) may be detected on the green fluorescence microscope. The first major peak with elution volume between 1 ml and 1.5 ml has three sub-peaks which could not be separated completely due to the insufficient resolution at the given molecular weight range of the selected column. However, by using the second derivative analysis of absorption at 500 nm, the approximate elution volumes can be estimated for streptavidin with one, two and three BSA molecules to be 1.05 ml, 1.15 ml and 1.3 ml respectively. The second major peak with the elution volume between 1.6 ml and 1.9 ml could be identified to be streptavidin with four Atto-488 dye molecules and, finally, the last well-defined peak with the elution volume between 2 ml and 2.3 ml may be the free biotinylated Atto-488 dye. The elution volume ranges may be used to estimate the complex size and effective charge with the corresponding confidence intervals. The effective charge versus the molecular size map can be plotted where the intensity of each point is binned and weighted with the 500 nm absorption intensity summarising the biophysical properties of the five Atto-488 labelled molecular complexes abundant in the mixture, as shown in FIGS. 6B and 6C.

In one example, the charge of a biotinylated Atto-488 dye may be measured to be (−0.99±0.11) e which appears to be in agreement with the expected charge of μₑ close to neutral pH conditions. Streptavidin with 4 bound dyes resulted in the size of (3.51±0.13) nm and the effective charge of around (−2.83±0.28) e. BSA at normal pH conditions has been known to have an effective charge of around −7e. Therefore, the expected effective charge of the Streptavidin-BSA complexes III-V, as shown in FIG. 4A, may be −9e, −15e and −21e respectively. The measured charge of the complexes III-V, (−13.5±0:9) e, (17.5±1.3) e and (−24.2±1.3) e respectively, appears to be in agreement qualitatively with the predictions. The slight negative bias can be explained by the fact that the complexes may not have been separated completely and there may be a small proportion of higher molecular mass species at the time of measurement on chip. The properties of the eluting molecules are summarised in FIG. 4C.

Referring to FIG. 7A, there is provided a spectrum showing the absorbance of Streptavidin, BSA and Atto-488 dye complexes at 500 nm after the Liquid Chromatography separation. The graph showed three distinct regions in the spectrum representing the five different labelled molecular complexes (I to V). In FIG. 7B, there is shown a second derivative of the spectrum between 1-1.5 ml, which reveals three most significant sub-peaks.

The system, apparatus, device and methods of the present invention have established a direct coupling between size exclusion chromatography with a parallelised microfluidic analysis while being able to fractionate about 90% of the total sample volume. The multidimensional characterisation of distinct complexes may be used to yield simultaneous size, electrophoretic mobility and effective charge measurements. As described herein, the operation principle of the present invention can be used for determining the biophysical properties of unlabelled standard analytes such as proteins within a mixture, as well as analysing multiple partially separated peaks after chromatographic separation and predicting the effective charge and molecular size of complexes of a heterogeneous labelled molecule within a mixture.

### EXAMPLE 1

To demonstrate the functionality of the method according to the present invention, a mixture of three proteins varying in size and isoelectric point (pI): bovine thyroglobulin (Mw=670 kDa, pI=4.5, GE Healthcare, 28-4038-42), chicken conalbumin (Mw=76 kDa, pI=6.7, GE Healthcare, 28-4038-42,) and chicken lysozyme (Mw=14.3 kDa, pI=9.3, Sigma-Aldrich, L6876) may be selected. The proteins can be diluted in a 100 mM sodium HEPES buffer (pH=7.3) at a ratio of 4.6:33:110 μM respectively; total sample volume 40 μL. The second system can be used to generate a heterogeneous sample based on Streptavidin-Biotin complex formation, which is one of the strongest known non-covalent interactions between a protein and a ligand. A mixture can be prepared by incubating Streptavidin (Prospec, Israel, PRO-791), biotinylated bovine serum albumin (Generon, UK, 7097-5) and a biotinylated Atto-488 (ATTO-TEC GmbH, Germany) dye at a ratio of 1:1:3 (20:20:60 μM, total volume 40 μL) for 1 hour at room temperature in 10% Phosphate buffered saline solution (0.1×PBS, pH=7.3). The mixture is expected to form seven distinct complexes with sizes ranging from 1 kDa to 300 kDa, as shown in FIG. 4A. Five of the complexes (I-V) contain an Atto-488 fluorophore and, therefore, the latter molecules can be the focus of detection and analysis.

Two different buffers may be used for the sample elution through the HPLC column. In a first instance, a 100 mM sodium HEPES buffer (pH=7.3) can be used for the label-free sample characterisation and streptavidin-biotin mixture may be eluted in a 0.1×PBS (pH=7.3) buffer. Both buffers may also contain 0.01% Sodium azide and 0.1% Tween to reduce sample adhering to microfluidic channels. A Superdex 200 Increase 3.2/300 column (GE Healthcare, UK) at a flow of 10 μL/min may be operated on an A KTA Pure System (GE Healthcare, UK). The eluting sample absorption at 280 nm and 500 nm wavelengths may be monitored simultaneously with a 10 mm path length absorption monitor U9-M (GE Healthcare, UK). The absorption intensity may be used for matching the molecular elution volume with the image sequence on a fluorescence microscope. The flow from the liquid chromatography (LC) separation can be connected to a microfluidic flow adapter.

A microfluidic junction (P-722, IDEX Health & Science, USA) with carefully pre-cut polyether ether ketone (PEEK) capillaries (IDEX Health & Science, USA) and flow sensors can be built, directing only a fraction of the flow coming from chromatographic separation into multiple microfluidic devices, as shown in FIG. 4C). The lengths of the capillaries may be as follows: the fractionator output can be made of a capillary with L_{f}=10.2 cm and 125 μm ID and the outputs A and B were made of two capillaries (L₁=10 cm with 125 μm ID and L₂=8.1 cm with 67.8 μm ID. Outputs A and B may be connected to microfluidic devices operating at flow rates close to few 100 μL/h. In general, the flow from the Liquid chromatography (LC) protein separation can be in the range of 10 μL/min-1 mL/min (600 μL/h—60 ml/h) depending on the pressure and column that may be used and, therefore, the capillary resistances may have to be fine-tuned for the desired flow splitting ratio.

The microfluidic device may be custom designed for fitting two distinct analytical blocks in one fluorescence microscope field of view. The first block—the diffusional sizing device—may have a long diffusion channel of length L_{D}=43 mm, width of W_{D}=300 μm and height of H_{D}=55 μm, as illustrated in FIG. 4D). The positions for the diffusion profile acquisition may be chosen to allow a high sizing dynamic range and fixed to distances of 3.1 mm, 8.8 mm, 12.4 mm, 17.9 mm, 21.5 mm, 36.7 mm and 40.3 mm from the sample injection point. a degassed co-flow buffer (same as the LC mobile phase) may be injected at a 290 μL/h flow rate with a neMESYS syringe pump (CETONI GmbH, Germany) into port 5 of the device, as shown in FIG. 5D. The Outlet A from the microfluidic flow adapter may be connected to the sample inlet (port 6) on the diffusional sizing device. The injected sample diffusion profile can be recorded and may be fitted to numerical diffusion simulations. By combining liquid chromatography and diffusional sizing inline the mixture may be separated to determine the diffusion constant D (and the hydrodynamic radius) of the separated mixture components eluting from the column.

Referring to FIG. 4D, the second component of the microfluidic chip can be a free-flow electrophoresis device with liquid electrodes, which may be designed to create up to 30 V/cm transverse electric fields on the microfluidic chip while avoiding bubble formation and electrolysis product build up on the chip. A conductive 3 M KCl electrolyte solution may be injected into ports 1 and 4, as shown in FIG. 4D, at flow rates of 150 μL/h. A degassed buffer solution may be injected at the port 2 at a flow rate of 300 μL/h using the neMESYS syringe pump and, finally, the output B from the fluidic adapter may be connected to port 3 of the free-flow electrophoresis device. Thus, the device of the present invention enables the electrophoretic mobility measurement of the separated molecular species eluting from the column by determining the sample deflection in the electrophoresis chamber in a transverse electric field. The mobility of a charged particle may be given by an equation:

$$μ = \frac{υ}{E} = \frac{Q}{V d h} x$$

where v is the transverse velocity, E—the applied electric field, x—the measured profile deflection, V—the applied voltage across the channel, d—the distance of the profile deflection measurement along the channel and h—the channel height.

Hollow metal with approximately 1.5 mm ID electrodes may be inserted into device ports 8 and 9 where a power supply (EA Elektro—Automatik 6230207, Germany) is connected to the chip via a digital multimeter (Agilent 34410A, USA) recording a current flowing through the circuit. The two microfluidic devices were operating continuously and a measurement of the hydrodynamic radius, electrophoretic mobility and charge were obtained for every 3.3 μL of the eluting sample (every 20 seconds) from the column while still fractionating 90% of the total volume.

The devices may be fabricated using a standard polydimetylsiloxane (PMDS) soft-lithography approach. The master for the replica molding of PDMS may be fabricated with an SU-8 photolithography process. After mixing PDMS (Sylgard184, Dow Corning, two components 10:1 ratio and degassed) and casting it onto the photo-lithographically defined structure, it is cured at 70° C. for 1 h. A carbon black nanopowder (Sigma-Aldrich) may be added to the PMDS before curing to create black devices, thus minimizing background noise and the unwanted autofluorescence from PDMS under 280 nm-LED illumination during the measurements. The PDMS replica of each master may then cut, and the connection holes may be made with a biopsy punch. The PDMS device may be sonicated for 3 min in isopropanol, blow dried with N2, and placed in an oven at 70° C. for 10 min. Finally, the replica may be activated using O2 plasma at a 40% power for 10 seconds (Diener etcher Femto, Germany) and bonded to a clean quartz slide (Alfa Aesar, 76.2 25.4 1.0 mm).

Regarding fluorescence microscope set up according to the present invention, one or more different fluorescence microscopes may be used for the experiments as described in the present invention. For example, an intrinsic fluorescence microscope for a label free protein detection and a green label epifluorescence measurement setup may be used. In one example, an auto-fluorescence measurement of proteins containing the aromatic amino acid tryptophan may be carried out on a quartz-based intrinsic fluorescence visualisation platform. In short, the proteins may be illuminated with a 25 mW 280 nm LED (M280L3, Thorlabs, UK) through an excitation filter (FF01-280/20-25, Semrock, USA) centered at a λₑₓ=280 nm and a dichroic mirror (FF310-Di01-25x36, Semrock, USA). The fluorescence from the sample may be collected through an emission filter (FF01-357/44-25, Semrock, USA) centered at λₑₘ=357 nm, and can be focused onto an EMCCD camera (Rolera EMC2, QImaging, Canada). The green epifluorescence microscope, as illustrated in FIG. 4C, may be optimised for the Green Fluorescent protein (GFP)/Alexa-488 detection comprising a 490 nm LED (M490L4, Thorlabs, UK), an excitation filter at 482±9 nm, a dichroic mirror (350-488 nm/502-950 nm) and the emission filter at 520±14 nm (filter set MDF-GFP2, Thorlabs, UK). The microscope may have a xyz stage for accurate chip positioning in the field of view of a 2.5× objective, and the pictures can be taken with a CCD camera (Retiga R1, QImaging, USA). A raw background corrected fluorescence image of a sample under test is shown in FIG. 3B.

In some embodiments, there may be a slight delay between the molecule absorption measurement after the LC separation and the detection on chip. The delay volume from the absorption measurement cell to the flow adapter can be 70 μL and the volume from the flow adapter to the chip detection channel is around 8 μL causing 20-30 min delay time depending on the system flow. The elution volume with the microscope image sequence may be matched by comparing absorption intensity on the absorbance detector (280 nm and 500 nm) and the fluorescence intensity of the eluting sample on chip.

The diffusion coefficient D can be used to quantify the fluctuations of a particle under Brownian motion and is described for a spherical particle by the Stokes-Einstein equation:

$$D = \frac{{k}_{B} T}{6 π η {R}_{h}}$$

where η is the viscosity of the solution, Rₕ is the hydrodynamic radius and k_{B} and T are the Boltzmann constant and absolute temperature, respectively. The measured diffusion constant D and the electrophoretic mobility μₑ can be used to estimate the complex charge:

$$q = \frac{{k}_{B} T}{D} {μ}_{e} \times \frac{1 + κ {R}_{h}}{f 1 ( κ {R}_{h} )}$$

where κ—the inverse Debye length and f₁ is a function of Rₕ that describes the effect of the electric field distribution around the particle. For most of the proteins in high salt buffers f₁ (κRₕ)≈1 since κRh<<1. Hence, the charge can be estimated by the Nernst-Einstein relation

$$q = Z e = \frac{{k}_{B} T}{D} {μ}_{e} = 6 π η {R}_{h} {μ}_{e}$$

### EXAMPLE 2

Referring to FIG. 8, there is provided an overview of an experimental set up for profiling particles such as proteins. The system and method of the present invention as shown in FIG. 8 comprises a protein mixture 48 provided onto a liquid chromatography column 50. The protein mixture 48 is being separated on the liquid chromatography column 50. For example, the liquid chromatography column 50 is able to separate a selected mixture of three proteins based on their individual properties such as size or isoelectric point (pI), while monitoring the separated sample absorption at multiple wavelengths 51. The eluted flow containing the separated mixture can then be directed into a flow adapter 54, where the flow adapter 54 is configured to distribute a part of the eluted fluid flow between a sample fractionation outlet 55 and a plurality of microfluidic analysis modules, i.e. a free-flow electrophoresis device 57 and a diffusional sizing device 59, arranged in parallel. The set up as shown in FIG. 8 ensures that the hydrodynamic radius and electrophoretic mobility of the eluent can be measured continuously on a microfluidic chip. The acquired information can then be processed and analysed to provide multidimensional information of individual species within a complex mixture.

The flow systems that are often used for liquid chromatography techniques for purification or separation of complex mixtures may not readily be compatible with microfluidic devices. In order to match macrofluidic flows of high pressure flow systems with microfluidic flows found in chips with micron sized features, the flow adapter 54 can be scalable to various rates. In some embodiments, the flow adapter 54 can be a macrofluidic or a microfluidic flow adapter.

As illustrated in FIG. 8, the incoming eluted fluid flow can be split into a multitude of outlets, each can be appropriately adjusted for specific applications e.g. for free-flow electrophoresis and/or for diffusional sizing. Therefore, the flow adapter interface enables a standard Liquid Chromatography (LC) fractionation followed by an instant multidimensional characterisation. The LC separation may be an AKTA Pure which drives two high pressure pumps maintaining a stable flow with around 1-5% fluctuation level depending on the buffer and the separation column. As shown in FIG. 11, the flow of the sample in the diffusion sizing device and the free flow electrophoresis device during the experiments is relatively constant.

The microfluidic flow adapter may be provided with resistances. The resistances of the flow adapter may be adjusted such that the flow adapter is able to distribute the incoming eluted fluid flow following the LC absorption cell between two or more microfluidic sample inlets and a fractionation outlet. In some embodiments, the flow can be tailored to the requirements of each downstream microfluidic device, for example each of the microfluidic devices may receive a different fluid flow i.e. not the same fluid flows. Alternatively, each of the microfluidic devices may receive the same or similar fluid flows. In some examples, the flow rates at the microfluidic inlets for the free-flow electrophoresis and the diffusional sizing devices are measured to be around 6.7±0.1% and around 6.2±0.1%, respectively, of the initial flow rate. The remaining portion of the post LC separation fluid (eluted flow) may not be used for further characterisation. Additionally or alternatively, the remaining portion of the post LC separation fluid can be collected via the fractionation outlet 55. By way of example only, the remaining portion of the post LC separation fluid can be 90% or it may be more than 90%. In some examples, the portion may be less than 90%, 80%, 70%, 60%, 50%, 40%, 30%, 20% or 10%. These ratios may be adapted to the microfluidic application used or separation procedure applied. The flow rates of the LC system can be dependent on the column used.

Referring to FIG. 8, the measurements taken from the free flow electrophoresis device 57 and the diffusional sizing device 59 in parallel can yield protein effective charge and, thus, the mixture component characteristics can be processed using a data processing module 160 such as a computer. The measurements can be visualised in a continuous 2-dimensional charge versus size map 60.

### EXAMPLE 3

Referring to FIGS. 9A and 9B, there are shown composition of molecule mixtures used for label-free and Atto488 labelled mixtures for Size Exclusion Chromatography Electrodiffusion measurements. A mixture of three proteins varying in size and isoelectric point (pI): bovine thyroglobulin (M_{w}=670 kDa, pI=4.5, GE Healthcare, 28-4038-42), chicken conalbumin (M_{w}=76 kDa, pI=6.7, GE Healthcare, 28-4038-42,) and chicken lysozyme (M_{w}=14.3 kDa, pI=9.3, Sigma-Aldrich, L6876) have been selected as shown in FIGS. 9A and 9B. The proteins are diluted in a 100 mM sodium HEPES buffer (pH=7.3) at a ratio of 4.6:33:110 μM, respectively; total sample volume is 40 μL. Two different buffers are used for the sample elution through the liquid chromatography column. A 100 mM sodium HEPES buffer (pH=7.3) can be used for the label-free sample characterisation.

In FIG. 9A, the proteins used for label-free detection are thyroglobulin (bovine), conalbumin (chicken) and lysozyme (chicken). In FIG. 9B, the labelled mixture comprises one or more components such as biotinylated Atto488, streptavidin and biotinylated bovine serum albumin (BSA). These components can be added to the protein mixture comprising thyroglobulin (bovine), conalbumin (chicken) and lysozyme (chicken). As shown in FIG. 9B, the components may form various complexes e.g. monovalent, divalent, trivalent and/or tetravalent complexes and be in different stoichiometry varying in size from 1 kDa to 320 kDa.

In order to detect and analyse unlabelled proteins in a mixture following size exclusion chromatography (SEC), a microscope 56 e.g. a UV-microscope set up capable to excite amino acids and in particular, aromatic amino acids is used to measure intrinsic protein fluorescence as illustrated in FIG. 8. Referring to FIG. 9A, the protein mixture may comprise the three unlabelled proteins thyroglobulin dimer (bovine), conalbumin (chicken) and lysozyme (chicken). The three proteins as shown in FIG. 9A vary in size from 14 to 670 kDa. Consequently, all three proteins are completely separated by a liquid chromatography column into three major peaks at volumes 1.06 mL, 1.52 mL and 2.12 mL, respectively, with a minor conalbumin oligomer peak at 1.34 mL, as shown in FIGS. 5A, 5B and 5C.

The eluting samples can be continuously loaded into a plurality of microfluidic analysis modules such as a free flow electrophoresis device and/or a diffusional sizing device as shown in FIG. 8. Each of the devices can be utilised to measure the electrophoretic mobility μₑ and hydrodynamic radius Rₕ of individual molecules in the sample mixture. The sample is loaded into an electrophoresis device guided between two liquid electrodes with a perpendicularly applied electric field. Conversely, the sample is loaded into the diffusion device between a simple buffer co-flow guided along a channel in order to follow the diffusion in a time resolved manner. Additionally or alternately, the flow through the diffusion channel could be split into two or more outlet channels and the signal in each outlet channel may be measured using a point detector to determine the amount of diffusion that the sample has undergone. The information obtained from the free flow electrophoresis device and the diffusional sizing device can be used to calculate the effective charge (q) of individual species, as shown in FIGS. 5A to 5C. To determine the properties of the separated molecular species more accurately, their corresponding elution volume have been aligned by setting a 10% maximum peak intensity threshold. The measured signal of thyroglobulin, conalbumin and lysozyme corresponds to the measured hydrodynamic radii of 7.86±0.30 nm, 3.96±0.14 nm and 2.20±0.14 nm, respectively, as shown in FIG. 5C. Referring to FIG. 5C, the effective charge at pH 7.4 of −19.4±1.3 e (Thyroglobulin), −0.8±0.3 e (Conalbumin) and 6.3±0.4 e (Lysozyme) have been simultaneously acquired. The measured isoelectric points for the three analysed proteins are pI=4.5 for thyroglobulin, pI=6.5-6.8 for conalbumin and pI=10.7 to 11.3 for lysozyme.

### EXAMPLE 4

Referring to FIGS. 10A to 10D, there is provided analytical data of a labelled streptavidin/BSA/Atto488 mixture characterised at three different pHs e.g. pH 6.5, 7.3 and 8.2. Additionally or alternatively, a heterogeneous sample can be produced based on streptavidin-biotin complex formation. A mixture is prepared by incubating streptavidin (Prospec, Israel, PRO-791), biotinylated bovine serum albumin (Generon, UK, 7097-5) and biotinylated Atto488 (ATTO-TEC GmbH, Germany) dye at a ratio of 1:1:3 (15.7:15.7:47.1 μM, total volume was 50 μL) for 1 hour at room temperature in 10% Phosphate buffered saline solution (0.1×PBS) at pH 6.5, 7.3 and 8.2, respectively. The mixture formed several complexes with sizes ranging from 1 kDa to 300 kDa, as shown in FIG. 9B. Five of the complexes formed comprise an Atto488 fluorophore. Alternatively, the streptavidin-biotin mixture can be eluted in a 0.1×PBS buffer with a pH of 6.5, 7.3 or 8.3. Both buffers also contained 0.01% Sodium azide and 0.1% Tween to reduce sample adhering to the walls of the microfluidic channels.

In FIG. 10A, the five identified labelled molecule complexes are characterised and 2-dimensional charge versus size maps are generated. The points are binned and weighed based on the absorption intensity at 500 nm. In FIG. 10B, the labelled mixture separated via LC at pH 6.5, 7.3 and 8.2. The hydrodynamic radii, electrophoretic mobility and effective charges of all eluted fluids are recorded. In FIG. 100, there is shown measured mobility of the individual identified species plotted against the different pH conditions and analysed further by linear regression. In FIG. 10D, the biophysical properties such as hydrodynamic radius, effective charge, theoretical (ExPASy) isoelectric point and experimental isoelectric point of the molecules within the mixture are measured and/or estimated after identification of the molecular elution volume ranges.

For the experimental data shown in FIGS. 10A to 10B, fluorescent labels may be used to increase sensitivity and specificity so that a detection of particular molecules is possible even in highly diverse mixtures and at low concentrations. It may be possible to monitor individual interactions of the fluorescent probe in complex solutions. A biotinylated Atto488 dye can be used to bind to streptavidin with an approximate affinity of K_{D}=10⁻¹⁵ M. The mixture can then be analysed under three different pH conditions, 6.5, 7.3 and 8.2. The LC separation of the Atto488 labelled streptavidin-biotin based system resulted in multiple sample elution peaks similar for all three conditions as shown in FIG. 10B. Simultaneously, the size and electrophoretic mobility of the eluting material can be determined using the above-described microfluidic devices with detection via an optical set up such as fluorescence detection set up or a fluorescence microscope. Detection here is exemplified by fluorescence but is not restricted to fluorescence. Alternative methods of detection may include, but not limited to absorption, bioluminescence, chemiluminescence, electrochemiluminescence, amperometry, voltammetry, conductometry, mass measurements or Raman spectroscopy. Referring to FIG. 10B, the information obtained from the size and electrophoretic mobility of the molecules are used to calculate the distinct net charge of each molecule. The effective charge versus the molecular size map where the intensity of each point is binned and weighted with the 500 nm absorption intensity summarising the biophysical properties of the five Atto488 labelled molecular complexes abundant in the mixture, as illustrated in FIG. 10A.

A further second derivative analysis on the absorption signal can be applied. In this case, only 4 distinct Atto488 labelled molecules and the free dye can be assigned. The first major peak with elution volume between 1 ml and 1.5 ml has three sub peaks. However, using the second derivative analysis of absorption at 500 nm, the approximate elution volumes for streptavidin with one, two and three BSA molecules are founded to be 1.11 ml, 1.20 ml and 1.33 ml respectively, as shown in FIG. 7B. Referring to FIGS. 7A and 7B, the second major peak with an elution volume between 1.5 ml and 1.9 ml could be identified to be streptavidin with four Atto488 dye molecules and, the last well-defined peak with an elution volume between 2 ml and 2.3 ml is the free biotinylated Atto488 dye.

Referring to FIG. 10D, the elution volume ranges are used to estimate the size and effective charge with the corresponding confidence intervals for each of the five species e.g. Atto488-Biotin, Strep+4×Atto488, Strep+3×Atto488/1×BSA, Strep+2×Atto488/2×BSA and Strep+1×Atto488/3×BSA. All molecules may possess a negative charge under measured conditions and, more specifically, the measured charge of a biotinylated Atto488 dye are −1.00±0.07 e at pH 7.3 which agrees with the expected charge of −1 e. Streptavidin with 4 bound dyes resulted in the size of 3.21±0.04 nm and the effective charge of around −2.77±0.12 e. As shown in FIG. 10D, the mono-, di-, and trivalent streptavidin-BSA complexes have hydrodynamic radii of 5.43±0.07 nm, 7.39±0.38 nm, 7.55±0.92 nm and effective charges of −13.18±0.51 e, −20.19±1.20 e and −23.19±1.43 e, respectively. In addition, FIGS. 10A to 10D also show the same characterisation for all five molecules at pH 6.5 and pH 8.2.

The electrophoretic mobility of the molecules over a range of different pH conditions can be used to identify the pI value of individual molecules. Referring to FIGS. 10A to 10D, streptavidin/BSA/Atto488 mixtures at pH 6.5, 7.3 and 8.2 are provided. By linear regression of mobility values at different pHs of individual species, the conditions can be extrapolated determine the pH at which the overall net charge is 0 (see FIG. 10C). The theoretical isoelectric point (pIₜₕₑₒ) can be determined by using the ExPASy platform which provides a prediction of the pI value based on the amino acid sequence of the molecule. The acquired experimental isoelectric point (pIₑₓₚ) value can be compared with the predicted pI value (pIₜₕₑₒ) obtained from the ExPASy sequence for all four protein species, as shown in FIG. 10D. In FIG. 10D, the results show a high similarity between the acquired pI value and the predicted pI value ranging from 6.1 of streptavidin with four dyes to 5.6 and 5.7, respectively, for streptavidin with three BSA. This shows that streptavidin on its own has a significantly higher pI than the dye and the pI of BSA is even lower than both of them.

### EXAMPLE 5

### Materials and Methods

A Superdex 200 Increase 3.2/300 column (GE Healthcare, UK) at a flow of 10 μL/min is operated on an AKTA Pure System (GE Healthcare, UK). The samples are monitored at absorption at 280 nm and 500 nm wavelengths simultaneously with a 10 mm path length absorption monitor U9-M (GE Healthcare, UK). The absorption intensity is used for matching the molecular elution volume with the image sequence on a fluorescence microscope. The flow from the LC separation is connected to the microfluidic flow adapter.

A microfluidic junction (P-722, IDEX Health & Science, USA) with polyether ether ketone (PEEK) capillaries (IDEX Health & Science, USA) and flow sensors (MF2 7 μL/min, Elveflow, France) are designed and manufactured to direct only a fraction of the flow coming from chromatographic separation into multiple microfluidic devices. The lengths of the capillaries are as follows: the fractionator output is made of a capillary with L₁=10.2 cm and 125 μm ID and the outputs A and B are made of two capillaries (L₁=10 cm with 125 μm ID and L₂=8.1 cm with 67.8 μm ID. Outputs A and B are connected to microfluidic devices operating at flow rates of between 90 to 100 μL/h. In general, the flow from the liquid chromatography (LC) protein separation can be in the range of 10 μL/min 1 mL/min (600 μL/h−60 ml/h) depending on the pressure and column used and, therefore, the capillary resistances can be tuned for the desired flow splitting ratio. The flow sensors may be integrated into AKTA Pure system with an I/O-box E9 for real time flow monitoring. Stable flow splitting may be achieved by directing approximately 10% of the total flow to different parts of the microfluidic chip. The flow rates at the diffusional sizing and the electrophoresis device sample inlets are measured to be 40.0±0.7 μL/h and 37.4±0.7 μL/h, respectively.

The microfluidic device is designed to fit two distinct analytical parts in one fluorescence microscope field of view. By way of example only, one part contains the diffusional sizing device and comprises a long diffusion channel of a length of L_{D}=43 mm, a width of W_{D}=300 μm and a height of H_{D}=55 μm. The positions for the diffusion profile acquisition are provided such that it may allow for a high sizing dynamic range and fixed to distances of 1.4 mm, 2.0 mm, 10.7 mm, 11.3 mm, 19.9 mm, 20.5 mm and 39.2 mm from the sample injection point. A degassed co-flow buffer (same as the LC mobile phase) is injected into the device at a flow rate of 150 μL/h, typically with the use of a neMESYS syringe pump (CETONI GmbH, Germany). The outlet of the microfluidic flow adapter is connected to the sample inlet on the diffusional sizing device. The diffusion profile of the injected sample is recorded and an analysis is performed via a fit to the numerical diffusion simulations.

The second part of the microfluidic chip is a free-flow electrophoresis device with one or more liquid electrodes. The free-flow electrophoresis device can be designed to create up to 60 V/cm transverse electric fields on the microfluidic chip whilst avoiding bubble formation and a build-up of electrolysis product(s) on the microfluidic chip. A conductive electrolyte solution e.g. 3 M KCl is injected into the free-flow electrophoresis device into an inlet from the side of the device at flow rate of 150 μL/h. The sample buffer solution is injected as a co-flow of the sample at a flow rate of 150 μL/h using a neMESYS syringe pump. The second output of the fluidic adapter is connected to the sample inlet of the free-flow electrophoresis device. The mobility of a charged particle is given by equation below:

$$μ = \frac{υ}{E} = \frac{Q}{V d h} x$$

where v is the transverse velocity, E—the applied electric field, x—the measured profile deflection, V—the applied voltage across the channel, d—the distance of the profile deflection measurement along the channel and h—the channel height. Hollow metal 1.5 mm ID electrodes are inserted into the liquid electrode channels on the sides of the device and connected to a power supply (EA Elektro-Automatik 6230207, Germany). The power supply is connected to the chip via a multimeter (Agilent 34410A, USA) recording a current flowing through the circuit.

The two microfluidic devices are operating continuously, and a measurement of the hydrodynamic radius, electrophoretic mobility and charge can be obtained for every 3.3 μL of the eluting sample (every 20 seconds) from the column while still fractionating 90% of the total volume.

The microfluidic devices can be fabricated using a standard polydimethylsiloxane (PDMS) soft-lithography approach. The master for the replica molding of PDMS is fabricated with an SU-8 photolithography process. After mixing PDMS (Sylgard184, Dow Corning, two components 10:1 ratio and degassed, mixed with carbon black nanopowder (Sigma-Aldrich) to create black devices) and casting it onto the photo-lithographically defined structure, it is cured at 70° C. for 1 h. Black devices can be advantageous as they can be used for minimizing background noise and the unwanted autofluorescence from PDMS under 280 nm-LED illumination during the measurements. Each PDMS replica of every master is then cut, and connection holes are made with a biopsy punch. To clean the PDMS devices they are sonicated for 3 min in isopropanol, blow dried with N₂, and placed in an oven at approximately 70° C. for 10 min. The replica is activated using O₂ plasma at a 40% power for 10 s (Diener etcher Femto, Germany) and bonded to a clean quartz slide (Alfa Aesar, 76.2×25.4×1.0 mm) for UV measurements or a simple glass slide for fluorescence measurements.

Various types of fluorescence microscopes can be used for the experiments as described in the present invention. For example, an intrinsic fluorescence microscope for a label free protein detection and a green label epifluorescence measurement setup can be provided. The autofluorescence measurements of proteins containing aromatic amino acids can be measured on an intrinsic fluorescence visualisation platform. Component in this platform may be made from quartz. Alternatively or additionally, components in this platform may be made from other glass-like and/or plastic materials with high transmittance and low autofluorescence for UV light. The proteins can be illuminated with a 25 mW 280 nm LED (M280L3, Thorlabs, UK) through an excitation filter (FF01-280/20-25, Semrock, USA) centred at a λₑₓ=280 nm and a dichroic mirror (FF310-Di01-25x36, Semrock, USA). The fluorescence from the sample may be collected through an emission filter (FF01-357/44-25, Semrock, USA) centred at λₑₓₘ=357 nm, and focused onto an EMCCD camera (Rolera EMC2, QImaging, Canada).

The green epifluorescence microscope, optimised for Green Fluorescent protein (GFP)/Alexa488 detection, comprises a 490 nm LED (M490L4, Thorlabs, UK), an excitation filter at 482±9 nm, a dichroic mirror (350-488 nm/502-950 nm) and the emission filter at 520±14 nm (filter set MDF-GFP2, Thorlabs, UK). The microscope may have a xyz stage for accurate chip positioning in the field of view of a 2.5× objective, and the pictures can be taken with a CCD camera (Retiga R1, QImaging, USA).

A small delay between the molecule absorption measurement after the LC separation and the detection on chip may be possible. The delay volume from the absorption measurement cell to the flow adapter is approximately 70 μL and the volume from the flow adapter to the chip detection channel is around 8 μL causing 20 to 30 minutes delay time depending on the system flow. The time delay can be matched by comparing the absorption intensity on the absorbance detector (280 nm and 500 nm) of the LC and the fluorescence intensity of the eluting sample on the microfluidic chip.

As illustrated in the equation below, a voltage V₀ can be applied to the electrophoresis device electrodes. Mobility measurements can be performed while the current flowing through the circuit I is recorded. The electrophoresis chamber of the device can be filled with a conductive electrolyte solution and the current I₀ is measured whilst applying the same voltage V₀.

V0=I(Relec+Rch),

V0=I0Relec,

⇒V=IR_{ch}=Relec(I₀−I)=V₀(1−I/I₀).
Relec and Rch are the resistances of the liquid electrodes and the separation channel, respectively. The equation below can be used to illustrate the distance along the direction of flow:

$${d}_{along} = {v}_{a l o n g} t = \frac{Q}{h w} t ⇒ t = \frac{{d}_{a l o n g} h w}{Q}$$

The equation below is used to express the mobility of the sample

$$μ = \frac{v}{E} = \frac{x}{t E} = \frac{x w Q}{V d h w} = \frac{Q}{V d h} x = \frac{Q}{{V}_{0} ( 1 - \frac{I}{{I}_{0}} ) d h} x$$

The total flow to the device Q=337 μL/h, V₀=60 V, d=2880 μm, h=55 μm, I=0.267±0.002 mA, I₀=0.283±0.001 mA.

The diffusion coefficient D quantifies the fluctuations of a particle under Brownian motion and is described for a spherical particle by the Stokes-Einstein equation as shown below:

$$D = \frac{{k}_{B} T}{6 π η {R}_{h}}$$

where η is the viscosity of the solution, Rₕ is the hydrodynamic radius and k_{B} and T are the Boltzmann constant and absolute temperature, respectively. The measured diffusion constant D and the electrophoretic mobility μₑ can be used to estimate the complex charge:

$$q = \frac{{k}_{B} T}{D} {μ}_{e} \times \frac{1 + κ {R}_{h}}{{f}_{1} ( κ {R}_{h} )}$$

where κ—the inverse Debye length and f₁ is a function of Rₕ that describes the effect of the electric field distribution around the particle. For most of the proteins in high salt buffers f₁(κRₕ)≈1 since κRₕ<<1. Hence, the charge can be estimated by the Nernst-Einstein relation:

$$q = Z e = \frac{{k}_{B} T}{D} {μ}_{e} = 6 π η {R}_{h} {μ}_{e}$$

As shown in FIG. 7B, a second derivative of the absorption intensity at 500 nm is taken. To take the second derivative, a Savitzky-Golay filter has been applied at least two times with 251 points: on the original spectrum and on the final second derivative of the spectrum. The three peaks can be identified as streptavidin with one, two and three BSA molecules, respectively.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

1. A device for profiling particles such as proteins, the device comprising:
a liquid chromatography column;
a plurality of microfluidic analysis modules;
wherein the microfluidic analysis modules are configured to provide multi-dimensional analysis of the particles; and
wherein the flow of fluid through the device is smoothed to provide a consistent and continuous fluid flow; and
further comprising a fractionation device that is provided downstream of the liquid chromatography column and upstream of the microfluidic analysis modules.

2. (canceled)

3. The device according to claim 1, further comprising a controller configured to use the multi-dimensional analysis obtained from the microfluidic analysis modules in order to assess the quality of the liquid chromatography column.

4. The device according to claim 2, wherein the controller is further configured to use the multi-dimensional analysis obtained from the microfluidic analysis modules in order to control the fractionation device.

5. The device according to claim 1, further comprising a detector configured to, detect and record data from each microfluidic analysis module.

6. The device according to claim 4, wherein the detector includes a microscope and a detector such as a camera for recording the data.

7. The device according to claim 5, wherein the detector is further configured to illuminate at least part of the microfluidic analysis module.

8. The device according to claim 6, wherein the illumination is provided by an LED or a laser.

9. The device according to claim 1, further comprising a flow adapter.

10. The device according to claim 1, further comprising a device for measuring optical absorption.

11. The device according to claim 5, wherein the microscope is an intrinsic fluorescence microscope.

12. The device according to claim 5, wherein the microscope is a epifluorescence microscope.

13. The device according to claim 5, wherein all of the data to be observed and recorded falls within the field of view of the microscope.

14. A method of multi-dimensional profiling of particles such as proteins present in a fluid sample; the method comprising the steps of:
introducing the fluid sample containing the particles to be profiled into a liquid chromatography column;
consistently and continuously flowing the fluid output from the column into each of a plurality of microfluidic analysis modules in parallel;
detecting data pertaining to multiple characteristics of the particles by observing the fluid within the microfluidic analysis modules; and
combining the data to calculate one of more attributes of the particle profile.

15. The method according to claim 14, wherein the characteristics detected include the hydrodynamic radius and the electrophoretic mobility.

16. The method according to claim 15, wherein the attribute calculated is the effective charge.

17. The method according to claim 14, wherein the characteristics detected are the mobility and diffusional size.

18. The method according to claim 17, wherein the attribute calculated is the isoelectric point.

19. The method according to claim 14, further comprising fractionating the fluid containing the particles.

20. The method according to claim 19, wherein the fractionation of the fluid includes 90% of the sample eluting from the liquid chromatography column.

21. The method according to claim 14, further comprising the step of measuring the hydrodynamic radius, electrophoretic mobility and/or effective charge of the particle or the intrinsic fluorescence of the particle.
